(19) United States
(12) Patent Application Publication
(10) Pub. No.: US 2014/0145443 A1
(43) Pub. Date: May 29, 2014

(54) WAVE POWER DEVICE WITH GENERATOR

(71) Applicant: Julius Espedal, Asker (NO)

(72) Inventor: Julius Espedal, Asker (NO)

(73) Assignee: LANGLEE WAVE POWER AS, Hvalstad (NO)

(21) Appl. No.: 13/880,723

(22) PCT Filed: Oct. 20, 2011
(86) PCT No.: PCT/NO2011/000296

§ 371 Date: Jun. 20, 2013

(30) Foreign Application Priority Data
Oct. 21, 2010 (NO) 20101480
Oct. 21, 2010 (NO) 20101481
Apr. 1, 2011 (NO) 20110504

(51) Int. Cl. F03B 13/18

(52) U.S. Cl. CPC F03B 13/181
USPC 290/53

(57) ABSTRACT

The present invention relates to a wave power device for converting energy of waves in a body of water to electrical energy. The device includes: a support structure; a panel, such as a flap or wing, hinged to the support structure, which panel is adapted to be moved by waves passing the device, resulting in a tilting or rotating motion of the panel relative to the support structure; and an electrical generator mechanically coupled to the panel, which electrical generator is adapted to convert the mechanical energy of the tilting or rotating motion of the panel to electrical energy. The present invention also relates to a use of such a wave power device, and a method for converting mechanical energy of a panel in a wave power device to electrical energy.

The present invention relates to a wave power device for converting energy of waves in a body of water to electrical energy. The present invention also relates to a use if such a wave power device, and a method for converting mechanical energy of a panel in a wave power device to electrical energy.

US2010111609 (Espedal) discloses a wave energy collecting apparatus comprising a frame including at least one hinged vertically tilting or rotating surface, such as a barrier in the form of a panel or a sail, for collecting energy from passing wave pressure fronts via a tilting or rotating motion within the frame, wherein the hinge is positioned below the surface of the fluid at the trough of the passing waves, said barrier being connected to a device capable of transforming the tilting or rotating motion into different types of energy, wherein the apparatus is located at a depth such that the tilting or rotating barrier breaks the surface of passing waves at the crest of the waves. The pressure from the waves causes the panel to rotate about the hinge. This generates pressure in a hydraulic pump. The pressure is transferred through a pipe to a hydraulic motor that is connected to an electric generator which produces electric power.

Further, WO2006/100436A1 (Aquamarine Power Limited) discloses a wave energy conversion device, for use in relatively shallow water, which has a base portion for anchoring to the bed of a body of water and an upstanding flap portion pivotally connected to the base portion. The flap portion is biased to the vertical and oscillates, backwards and forwards about the vertical in response to wave motion acting on its faces. Power extraction means extract energy from the movement of the flap portion. Specifically, the power extraction means comprises a hydraulic motor, which is connected via a flywheel energy store to a variable speed electrical generator system.

However, a drawback with the apparatus in US2010111609 and the device in WO2006/100436A1 is that the means for converting the motion of the panel or flap to electricity is complicated (US2010111609 as well as WO2006/100436A1 uses a hydraulic system for energy conversion) and requires a lot of maintenance and also suffers from high energy losses.

It is an object of the present invention to at least partly overcome the above drawback(s), and to provide an improved wave power device, which device in particular is robust and efficient when in comes to converting the motion of a panel thereof to electricity.

These objects, and other objects that will be apparent from the following description, are achieved by a wave power device, a use thereof, and a method for converting mechanical energy of a panel in a wave power device to electrical energy according to the appended independent claims. Embodiments are set forth in the appended dependent claims.

According to an aspect of the present invention, there is provided a wave power device for converting energy of waves in a body of water to electrical energy, the device comprising: a support structure; a panel, such as a flap or wing, hinged to the support structure, which panel is adapted to be moved by waves passing the device, resulting in a tilting or rotating motion of the panel relative to the support structure; and an electrical generator mechanically coupled to the panel, which electrical generator is adapted to convert the mechanical energy of the tilting or rotating motion of the panel to electrical energy.

By having an electrical generator mechanically coupled to the panel, no hydraulics system is needed nor used. This provides for a robust wave power device with reduced maintenance requirements, since fewer parts are required for the energy conversion. Also, by omitting any hydraulics system or similar between the panel and the electrical generator, energy (conversion) losses are reduced and the power efficiency is improved.

In one embodiment, the device further comprises a gear mechanism, wherein the electrical generator is coupled to the panel via said gear mechanism. The gear mechanism may have a gear ratio that increases the speed of the electrical generator compared to the tilting or rotating motion of the panel. The gear mechanism may for instance have a gear ratio of 1:10 (panel:electrical generator). Increasing the speed of the generator makes the electricity generation in the present device more efficient.

The gear mechanism may include a larger diameter ring connected to the panel and provided with teeth, and a smaller diameter pinion connected to the electrical generator and adapted to mesh with the teeth of said ring. Further, the support structure may include a substantially horizontal elongated element, such as a bar or tube, wherein the panel is attached to the said element by means of at least one bearing provided around the element, said ring of the gear mechanism is also provided around said element, and the pinion is provided on an axis substantially parallel to said element.

Alternatively, the gear mechanism may include a planetary gear at least partly provided inside a tube element of the support structure, and wherein the electrical generator is also provided inside said tube element. The planetary gear may comprise one or more planet gears which partly extend outside the tube element through respective openings in the tube element, and an outer ring gear which meshes with the planet gears at said openings, and which is connected to the panel such that rotation or tilting of the panel is transferred to said outer ring gear. The planetary gear may further comprise a central sun gear which meshes with the planet gears and which is coupled to the electrical generator, and a stationary carrier on which the planet gears are mounted. The wave power device may further comprise a housing accommodating the outer ring gear, a drive ring attached on one hand to the outer ring gear via a house opening in said housing and on the other hand to said panel, and sealing members arranged to prevent any fluid or particles from entering said housing via said house opening. Further, the gear mechanism may include includes, arranged between said planetary gear and electrical generator, at least one second planetary gear.

In another embodiment, the electrical generator may be direct-coupled to the panel. This provides for a very robust wave power device with a minimum of parts. The support structure may include a substantially horizontal elongated element, such as a bar or tube, wherein the panel is attached to said element by means of at least one bearing provided around the element, and the electrical generator is ring-shaped and also provided around said element.

Further, at least one of the electrical generator and any gear mechanism may be mounted on the outside of the support structure. By placing the electrical generator (and/or any gear mechanism) outside the support structure, there is no need of having any waterproof connections through the support structure, much of the interior of the support structure can be used for containing ballast water (see below), and the body of water in which the present device when in use is placed “automatically” provides for good cooling of the outside electrical generator (and any gear mechanism). Overall, improved power efficiency and improved cooling is achieved.

Also, the axis or center of rotation (or tilting) of the panel may be inside the support structure.

The wave power device may further comprises at least one ballast tank provided inside the support structure, and means for filling and emptying the at least one ballast tank. The at least one ballast tank and the means for filling and emptying the at least one ballast tank may be of the type disclosed in the applicant's co-pending application entitled “Wave power device with at least one ballast tank”, the contents of which herein is incorporated by reference, or of the type disclosed later in this application.

The wave power device may further comprise a release mechanism adapted to decouple (mechanically or electrically) the electrical generator when a force acting on the panel exceeds a particular value. When the electrical generator is decoupled, the panel does not generate electricity, but just moves along with the waves, whereby forces on the wave power device can be minimized in case unusually powerful waves hit the device.

Another aspect of the present invention relates to a use of a wave power device according to the above description for converting energy of waves in a body of water to electrical energy by placing such a wave power device in the body of water. This aspect may exhibit the same of similar features and technical effects as the previously described aspect of the invention.

According to yet another aspect of the present invention, there is provided a method for converting mechanical energy of a panel in a wave power device to electrical energy, wherein the wave power device includes a support structure and the panel, for instance a flap or wing, is hinged to the support structure, the panel being adapted to be moved by waves passing the device resulting in a tilting or rotating motion of the panel relative to the support structure, which method comprises: providing an electrical generator mechanically coupled to the panel, either directly or via a gear mechanism, the electrical generator being adapted to convert the mechanical energy of the tilting or rotating motion of the panel to electrical energy. This aspect may exhibit the same or similar features and technical effects as the previously described aspects of the invention.

These and other aspects of the present invention will now be described in more detail, with reference to the appended drawings showing currently preferred embodiments of the invention.

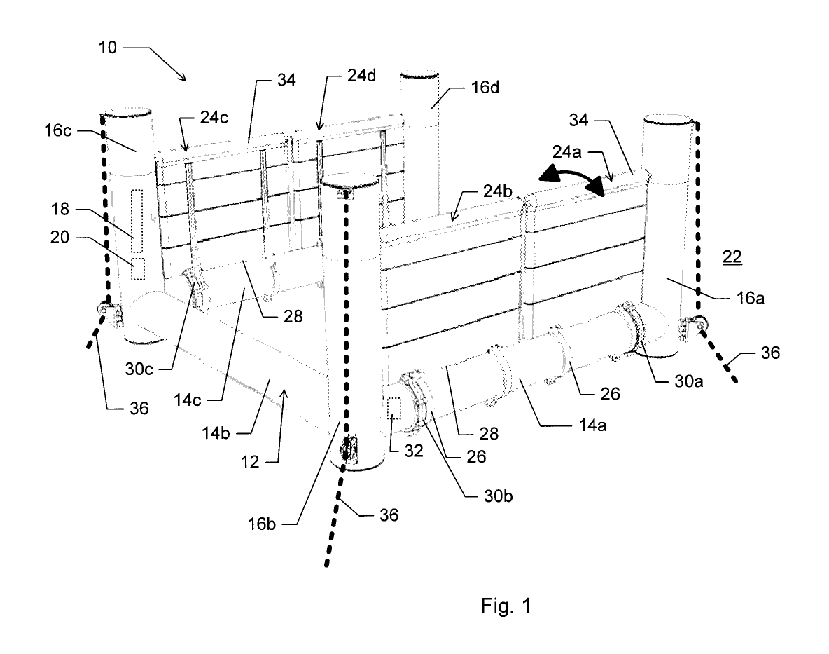

FIG. 1 is a perspective view of a wave power device according to an embodiment of the present invention.

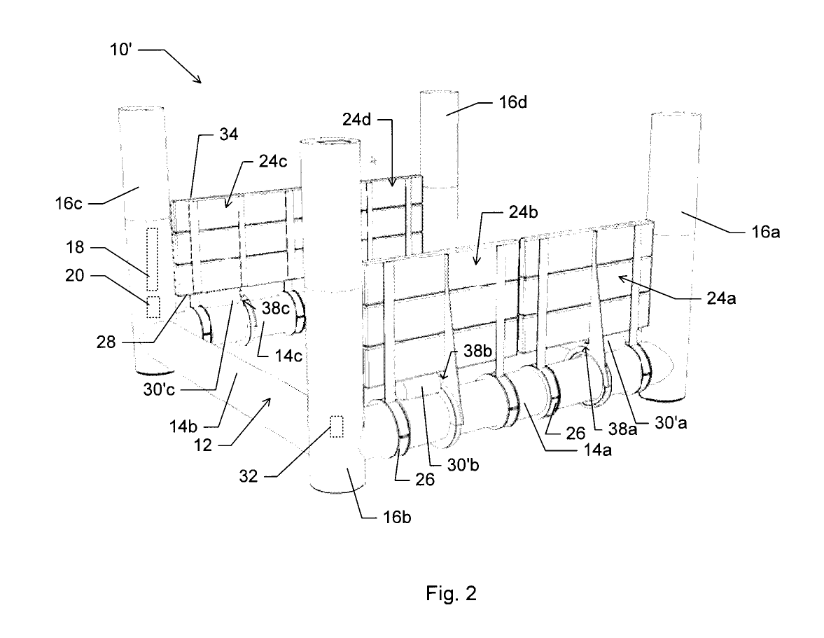

FIG. 2 is a perspective view of a wave power device according to another embodiment of the present invention.

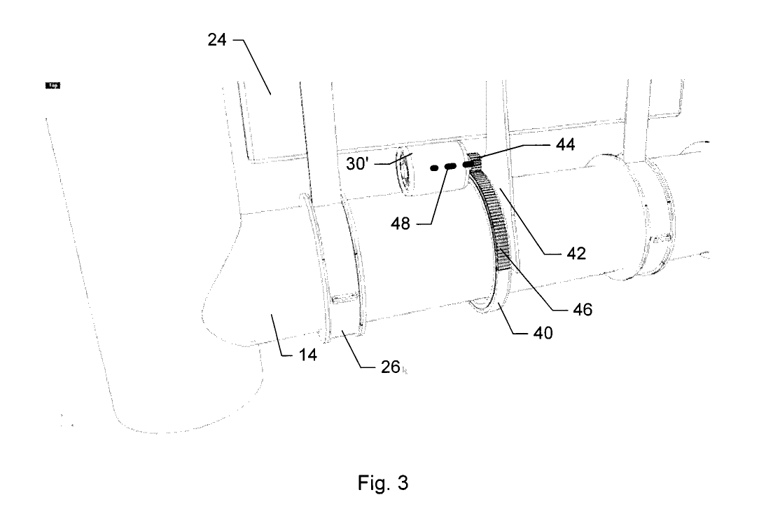

FIG. 3 shows a gear mechanism in the device of FIG. 2.

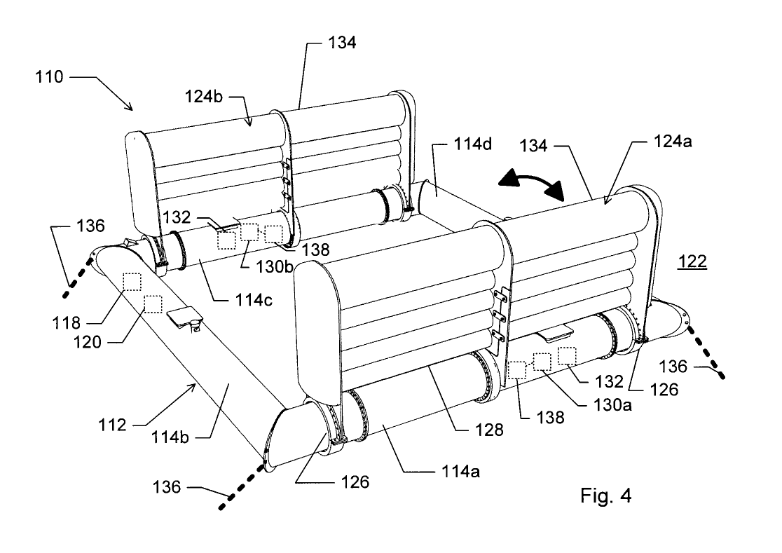

FIG. 4 is a perspective view of a wave power device according to yet another embodiment of the present invention.

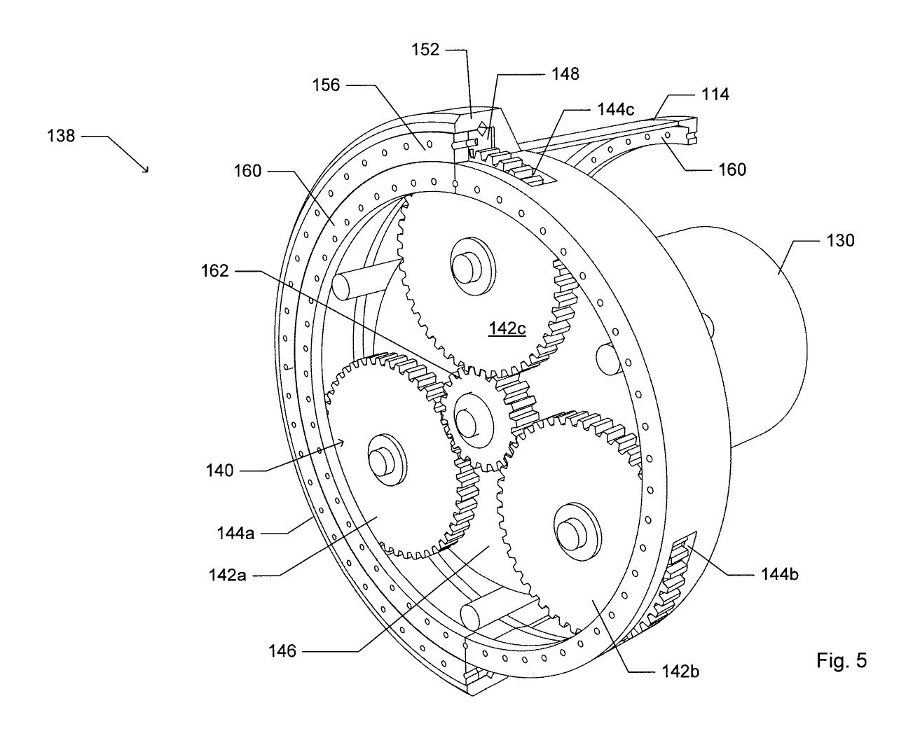

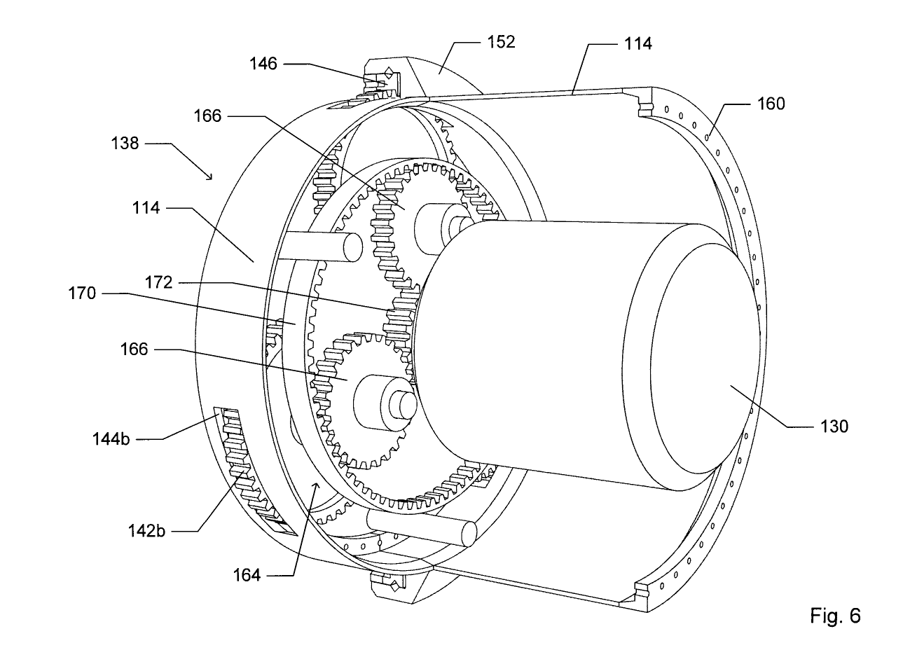

FIGS. 5-6 are perspective views partially in cross-section illustrating a system/gear mechanism incorporated in the device of FIG. 4.

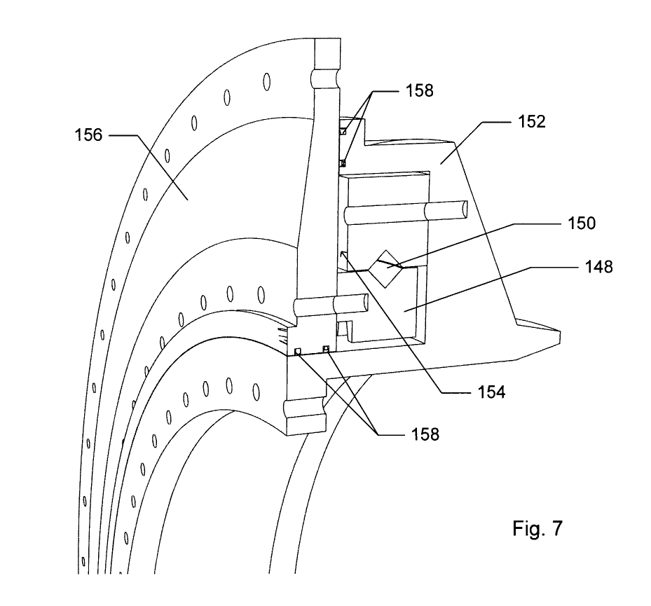

FIG. 7 is a partial view illustrating the arrangement of an outer ring gear of the system/gear mechanism in FIGS. 5-6.

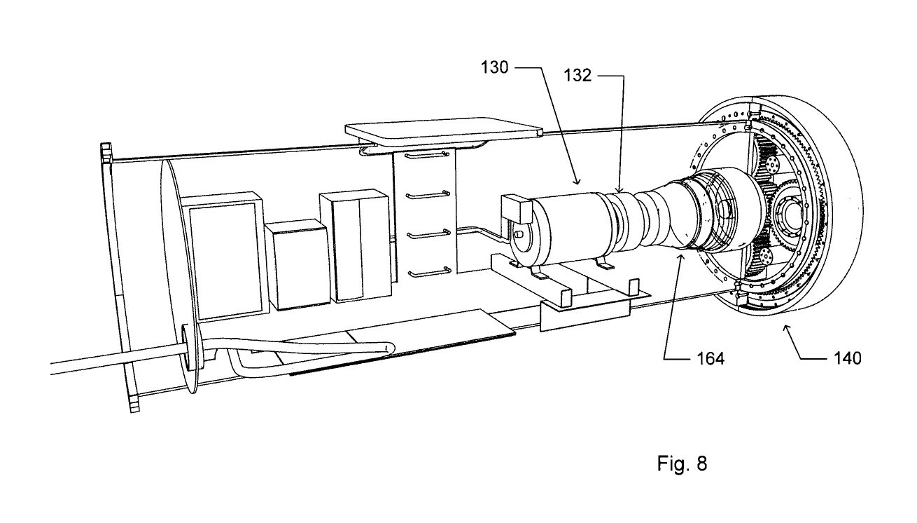

FIG. 8 is a perspective view showing details of the interior of the device in FIG. 4.

FIG. 1 is a perspective view of a wave power device or plant 10 according to an embodiment of the present invention.

The wave power device 10 comprises a support structure 12. The support structure 12 includes four horizontal cylindrical tubes 14a-d forming part of a square or rectangle. At each corner of the square or rectangle, there is erected an upright tube 16a-d. It should be noted that ‘horizontal’ and ‘upright’ (or ‘vertical’) here refers to an envisaged typical orientation of the wave power device 10 as shown in FIG. 1, but of course the actual orientation of the device 10 when in operation can vary e.g. due to incoming waves.

The wave power device 10 may further comprise at least one water ballast tank 18 provided inside the tubes 14 and/or 16, and means 20 for filling ballast water from a surrounding body of water 22 into the at least one ballast tank 18 and for emptying ballast water from the at least one ballast tank 18. Such means 20 may include an inlet/outlet valve and a pump. The at least one ballast tank 18 and the means 20 are only schematically indicated in FIG. 1.

The wave power device 10 further comprises four panels 24a-d. Each panel 24 is in the form of a flap or wing. Two panels 24a-b are attached to one of horizontal tubes 14a, while the other two panels 24c-d are attached to the opposite horizontal tube 14c. Each panel 24 is horizontally hinged to its horizontal tube 14 by means of at least one bearing 26. Each bearing 26 is provided around the horizontal tube 14 in question, with an inner ring of the bearing 26 attached to the tube 14, and an outer ring of the bearing 26 attached to the (lower) edge 28 of the panel 24. In this way, the panels 24 may rotate 360 degrees about their respective support tube 14, though restrictions could be added to limit the rotation or tilting of the panels 24.

Further, each panel 24 is buoyant or includes buoyant elements so that the panels 24, when the wave power device 10 is at least partly submerged in a body of water, strive towards the vertical. Alternatively or complementary, means for biasing the panels 24 towards the vertical may be included in the wave power device 10. Such means may for instance include springs or the like attached between the support structure and the panels.

The wave power device 10 further comprises a plurality of electrical generators 30a-d, preferably one electrical generator 30 per panel 24. Each electrical generator 30 is ring-shaped and provided around the horizontal tube 14 in question, next to the bearings 26, as shown in FIG. 1. Each electrical generator 30 is further mechanically direct-coupled to its panel 24, namely to the lower edge 28 of its panel 24, such that mechanical energy of a tilting or rotating motion of the panel 24 about its support tube 14 may be converted by the electrical generator 30 to electrical energy or electricity. Examples of electrical generators that could be used in the present device are models XTLV3 and XTHV1000 commercially available from Smartmotor AS in Norway.

The wave power device 10 may further comprise a release mechanism schematically indicated by reference sign 32. The release mechanism 32 is adapted to automatically decouple one or more of the electrical generators 30 when a force acting on the respective panel(s) 24 exceeds a particular value. The electrical generator(s) 30 may be physically and mechanically decoupled from the panel(s) 24, or the generator(s) 30 may be electrically disconnected from the electricity grid or similar. When an electrical generator 30 is decoupled, its associated panel 24 does not generate electricity, but just moves along with the waves, whereby forces on the wave power device 10 can be minimized in case unusually powerful waves hit the device, like a so-called hundred-year wave.

In use or operation, the wave power device 10 is at least partly submerged in the body of water 22, typically the sea, such that upper edges 34 of the panels 24 when the latter are in a vertical position are just above the water surface. To this end, the wave power device 10 may be floating or floatable, and any ballast tank(s) 18 may be used to carefully control the depth of the device 10. Anchoring equipment 36 may be used to anchor the wave power device 10 to the seabed. In an alternative embodiment, the device 10 may stand directly on the seabed. In another alternative embodiment, the device 10 is kept in a GPS position by means of a DPS (Dynamic Position System), where propellers or the like are used to compensate for any deviation or drift.

Waves approaching and passing the wave power device 10 move the panels 24, resulting in a tilting or rotating motion of the panels 24 relative to the support structure 12 (indicated by the curved arrow in FIG. 1), as in the above mentioned US2010111609, the contents of which herein is incorporated by reference. The mechanical energy of the tilting or rotating motion of the panel 24 is in the present device 10 directly converted to electricity by means of the electrical generator 30 which is mechanically coupled to the panel 22. This allows improved robustness and reduced energy (conversion) losses, as discussed above.

It should be noted that the power take off means (i.e. the generators 30) are provided outside the tubes 14a, 14c, but the rotation points or axes of the panels 24 are inside the tubes 14a, 14c. The latter balances the forces on the wave power device, while no through-going bushings in the support structure 12 are required for the power take off means, whereby the overall strength of the device 10 is improved.

FIG. 2 is a perspective view of a wave power device 10′ according to another embodiment of the present invention. The wave power device 10′ of FIG. 2 may be similar to the wave power device 10 of FIG. 1, but the device 10′ further includes gear mechanisms 38a-d connected between each panel 24 and a respective electrical generator 30′. The gearing mechanisms 38 are generally provided to increases the speed of the electrical generators 30′ compared to the tilting or rotating motion of the panels 24, to make the electricity generation more efficient. To this end, a suitable a gear ratio of the gearing mechanism 38 is 1:10 (panel:electrical generator), though other ratios wherein the speed of the electrical generator 30′ is increased compared the tilting or rotating motion of the panel 24 are envisaged.

An example of a gearing mechanism 38 is shown in detail in FIG. 3. Each gearing mechanism 38 includes a larger diameter ring 40 provided around the tube 14a or 14c. The ring 40 is attached to a part 42 (e.g. similar to bearing 26) that rotates or pivots along with the panel 24.

Each gearing mechanism 38 further includes a pinion 44. The pinion 44 has a smaller diameter than the ring 40, and it is arranged to mesh with the teeth 46 of the larger diameter ring 40. The pinion 44 is further connected to the generator 30′ via an axis schematically indicated by 48, which axis 48 may be substantially parallel to the tube 14a or 14c. Here, the electrical generator 30′ is not a ring-shaped electrical generator like in FIG. 1, but it can instead be of a more conventional type.

In an alternative embodiment (not shown) of the wave power device 10′, the larger diameter ring may be provided with teeth on the inside, while the outside of the ring is attached to a respective panel, for instance at the lower edge thereof. The larger diameter ring is further accommodated in a housing formed by two outer rings and an inner ring. This accommodation allows the larger diameter ring to freely rotate about the horizontal tube of the support structure along with the panel. Further, the pinion is in this embodiment arranged to mesh with the teeth of the larger diameter ring at an opening in the inner ring.

In use or operation, the wave power device 10′ functions similar to the wave power device 10 of FIG. 1, but the gearing mechanisms 38 increase the speeds of the electrical generators 30′, whereby the electricity generation becomes more efficient.

FIG. 4 is a perspective view of a wave power device 110 according to yet another embodiment of the present invention.

The wave power device 110 comprises a support structure 112. The support structure 112 includes four horizontal cylindrical tubes 114a-d forming part of a square or rectangle. At each corner of the square or rectangle, there may be erected an upright tube. It should be noted that ‘horizontal’ and ‘upright’ (or ‘vertical’) here refers to an envisaged typical orientation of the wave power device 110 as shown in FIG. 4, but of course the actual orientation of the device 110 when in operation can vary e.g. due to incoming waves.

The wave power device 110 may further comprise at least one water ballast tank 118 provided inside (one or more of) the tubes 114, and means 120 for filling ballast water from a surrounding body of water 122 into the at least one ballast tank 118 and for emptying ballast water from the at least one ballast tank 118. Such means 120 may include an inlet/outlet valve and a pump. The at least one ballast tank 118 and the means 120 are only schematically indicated in FIG. 4.

The wave power device 10 further comprises two panels 124a-b. Each panel 124 is in the form of a flap or wing. One panel 124a is attached to one of horizontal tubes 114a, while the other panel 124b is attached to the opposite horizontal tube 14c. Each panel 124 is horizontally hinged to its horizontal tube 114 by means of at least one bearing 126. Each bearing 126 is provided around the horizontal tube 114 in question, with an inner ring of the bearing 126 attached to the tube 114, and an outer ring of the bearing 126 attached to the (lower) edge 128 of the panel 124. In this way, the panels 124 may rotate 360 degrees about their respective support tube 114, though restrictions could be added to limit the rotation or tilting of the panels 124. Alternatively, two panels may be attached to horizontal tube 114a, while two panels may attached to horizontal tube 114c.

Further, each panel 124 is buoyant or includes buoyant elements so that the panels 124, when the wave power device 110 is at least partly submerged in a body of water, strive towards the vertical. Alternatively or complementary, means for biasing the panels 124 towards the vertical may be included in the wave power device 110. Such means may for instance include springs or the like attached between the support structure and the panels.

The wave power device 110 further comprises one or more electrical generators 130, preferably one electrical generator 130 per panel 124. The one or more electrical generators 130 are provided inside the horizontal tubes 114, as will be explained more in the following.

The wave power device 110 further includes gear mechanisms 138 connected between each panel 124 and a respective electrical generator 130. The gear mechanisms 138 are generally provided to increases the speed of the electrical generators 130 compared to the tilting or rotating motion of the panels 124, to make the electricity generation more efficient. To this end, a suitable a gear ratio of the gear mechanism 138 is 1:10 (panel:electrical generator), though other ratios wherein the speed of the electrical generator 130 is increased compared the tilting or rotating motion of the panel 124 are envisaged.

An example of a system/gear mechanism 138 is shown in detail in FIGS. 5-6. Reference is also made to FIG. 7. The gear mechanism includes a first planetary gear or gearing 140 (also referred to as epicyclic gear or gearing) partly provided inside one of the horizontal tubes (tube element) 114 that supports a panel 124. The planetary gear 140 inside the cylindrical tube element 114 may be provided in a closed compartment at least partly filled with lubricating oil, with a partition wall (not shown) between the compartment and the generator 130.

The planetary gear 140 includes one or more planet gears (preferably two or more) 142 which partly extend outside the tube element 114 through respective openings 144 in the tube element 114. The planet gears may also be referred to as planet wheels. In the exemplary shown in FIGS. 5-6, the planetary gear 140 includes three planet gears 142a-c, and the tube element 114 has three openings 144a-c. Preferably, the openings 144 are evenly distributed about the circumference of the tube element 114, and each planet gear 142 is arranged so that a teethed portion or sector thereof protrudes outside the tube element 114. All planet gears 142a-c may be of the same size. Further, the planet gears 142 are mounted on a carrier 146, which carrier 146 preferably is stationary in relation to the tube element 114.

The planetary gear 140 further includes an outer ring gear 148 which meshes with the planet gears 142 at said openings 144. The outer ring gear 148 is provided on the outside, around the tube element 114 for rotation about the latter, and it has inward-facing teeth that mesh with the planet gears 142. Ball bearings, roller bearings, crosshead bearings, slide bearings or the like 150 may be provided to allow the outer ring gear 148 to rotate with little or no friction. The outer ring gear 148 may be referred to as a slewing ring with internal teeth. It is also envisaged that the outer ring gear 148 may be held only by the planet gears 142.

The outer ring gear 148 is accommodated in a housing 152 on the outside of the tube element 114. The housing 152 preferably extends all around the tube element 114. The housing has an opening (house opening) 154 in one side thereof. At this opening 154, the outer ring gear 148 is attached to a drive ring 156. The drive ring 156 is preferably made of corrosion resistant material, since it will be exposed to seawater during use of the device 110. The drive ring 156 is also attached to the panel 124, such that rotation or tilting of the panel 124 may be transferred to the outer ring gear 148.

The housing 152 serves to hold the outer ring gear 148, and it also serves to transfer forces induced via the tilting panel 124 to the tube element 114 and the rest of the support structure 112. Between the drive ring 156 and the housing 152, there are gaskets (sealing members) 158, one upper pair and one lower pair as seen from FIG. 7. The gaskets 158 prevent any fluid (e.g. seawater) or particles to enter the housing 152 via opening 154 and further into the tube element 114 from the external environment. The space between the two gaskets 158 in each pair can be filled with water repellent lubricant or an overpressure of air to further secure against water penetration. The lubricant can be continuously and automatically supplied in manners known per se.

In case the tube element is vertically arranged in water, the use of gaskets could be reduced or removed by creating an overpressure of air inside the tube element. The overpressure prevents water from entering into the tube element via openings 144 and 152.

The portion of the tube element 114 including the gear mechanism 138 and optionally the generator 130 may a separate module that can removably attached to the rest of the tube element 114. Such a portion can at each end thereof be provided with a flange 160 so that the portion can be secured (e.g. screwed) to the remaining tube element.

The planetary gear 140 further includes a central sun gear 162 (may also be referred to as a sun wheel). The sun gear 162 meshes with the planet gears 142. The axes of all gears 142, 148, 162 are usually parallel, and they are also generally parallel to the tube element 114.

The gear mechanism 138 further comprises a second planetary gear 164, which has two or more (here three) planet gears 166, a carrier (not shown) on which the planet gears 166 are mounted, an outer ring gear 170, and a central sun gear 172. The sun gear 162 of the first planetary gear 140 is coupled directly to the carrier of the second planetary gear 164, and the outer ring gear 170 of the second planetary gear 164 is stationary in relation to the tube element 114. Further, the sun gear 172 of the second planetary gear 164 is coupled to the electrical generator 130, such that rotary motion of the sun gear 172 is transferred to electrical generator 130 which in turn may convert the rotary motion to electrical energy. The sun gear 172 may be coupled to the electrical generator 130 either directly, via a shaft, or via some other means (such as a third planetary gear).

The wave power device 10 may further comprise a release mechanism schematically indicated by reference sign 132. The release mechanism 132 is adapted to automatically decouple one or more of the electrical generators 130 when a force acting on the respective panel(s) 124 exceeds a particular value. The electrical generator(s) 130 may be physically and mechanically decoupled from the panel(s) 124, or the generator(s) 130 may be electrically disconnected from the electricity grid or similar. When an electrical generator 130 is decoupled, its associated panel 124 does not generate electricity, but just moves along with the waves, whereby forces on the wave power device 110 can be minimized in case unusually powerful waves hit the device, like a so-called hundred-year wave.

In use or operation, the wave power device 110 is at least partly submerged in the body of water 122, typically the sea, such that upper edges 134 of the panels 124 when the latter are in a vertical position are just above the water surface. To this end, the wave power device 110 may be floating or floatable, and any ballast tank(s) 118 may be used to carefully control the depth of the device 110. Anchoring equipment 136 may be used to anchor the wave power device 110 to the seabed. In an alternative embodiment, the device 110 may stand directly on the seabed. In another alternative embodiment, the device 110 is kept in a GPS position by means of a DPS (Dynamic Position System), where propellers or the like are used to compensate for any deviation or drift.

Waves approaching and passing the wave power device 110 move the panels 124, resulting in a tilting or rotating motion of the panels 124 relative to the support structure 112 (indicated by the curved arrow in FIG. 4). The mechanical energy of the tilting or rotating motion of the panel 124 is in the present device 110 directly converted to electricity by means of the electrical generator 130 which is mechanically coupled to the panel 122 via the gear mechanism 138.

In particular, the motion of the panel 124 is conveyed via the drive ring 156 to motion of the outer ring gear 148 which hence rotates about the tube element 114. The carrier 146 is stationary in relation to the tube element 114, whereby rotation of the outer ring gear 148 causes rotation of both the planet gears 142 and the sun gear 160. In other words, for the first planetary gear 140, the planet carrier 146 is stationary, the outer ring gear 148 is ‘input’ (providing power to the system), and the sun gear 160 is ‘output’ (receiving power from the system).

The rotation of the sun gear 160 causes the carrier of the second planetary gear 164 to rotate. As the outer ring gear 170 is stationary, this causes the sun gear 172 of the second planetary gear 164 to rotate, which in turn powers the generator 130. Hence, for the second planetary gear 164, the planet carrier is ‘input’, and the sun gear 172 is ‘output’. Alternatively, in the second planetary gear 164, the planet carrier may be stationary, while the outer ring gear 170 is ‘input’ and the sun gear 172 is ‘output’.

The gear mechanism described above with reference to FIGS. 5-7 may be denoted a ‘two-stage planetary gear’. However, it should be noted that the second planetary gear 164 could be omitted, in which case the sun gear 162 of the first planetary gear 140 is coupled directly to the generator 130 (‘one-stage planetary gear’). But two or more planetary gears result in a greater gear ratio.

FIG. 8 is a perspective view showing details of the interior inside one of the tubes 114 of the device in FIG. 4. From right to left there is the planetary gear 140, the second planetary gear (and optional third planetary gear) 164, the release mechanism 132 here in the form of a clutch for mechanical disconnection between the gear mechanism and the generator 130, a manhole/ladder, two inverters, fuse/disconnecting switch, and export cable.

In the embodiment described in relation to FIGS. 4-8, full strength in the tube element 114 is achieved, also through the gear mechanism. At the same time, no limitation with respect to rotation angle of the panel(s) 124 is necessary. Further, the present embodiment is less sensitive to tampering from the outside, since the generator and many other components are provided inside the tube element and are hence protected from the surrounding environment. Also, great torques can be transferred from the panel to the generator, since three or more gear wheels transfer the motion. Also, the motion transfer can be geared up or down. Also, when servicing the wave power device, the complete tube portion including the gear mechanism can be removed and replaced.

The above described devices 10 and 10′ and 110 may for instance be deployed in areas with moderate wave conditions, namely 2-6 meter seas, and they may form part of an offshore wind farm site.

The person skilled in the art will realize that the present invention by no means is limited to the embodiments described above. On the contrary, many modifications and variations are possible within the scope of the appended claims

For instance, even though the claims recite ‘a panel’ and ‘an electrical generator’ etc., this does not exclude that the present device can include further such elements, as exemplified above. Also, the upright tubes 16a-d could be omitted.

According to another aspect, there is provided a floatable wave power device 210 for converting energy of waves in a body of water 224 to electrical energy, the device comprising: a support structure 212; at least one panel 220, such as a flap or wing, hinged to the support structure, which at least one panel is adapted to be moved by waves passing the device, resulting in a tilting or rotating motion of the at least one panel relative to the support structure; at least one ballast tank 228; and means 236 for filling and emptying the at least one ballast tank.

The at least one ballast tank and the means for filling and emptying the at least one ballast tank may be used to carefully control the (floating) depth of the wave power device in the water. Further, the wave power device being floatable means that it easily can be towed into place in the body of water without using a transportation barge or the like. Without ballast or with just little ballast in the ballast tank(s), the wave power device may be launched in a relatively shallow body of water, and the draft of the wave power device may be minimized to facilitate the towing of the wave power device. Also, attaching moorings and/or anchors to the wave power device may be facilitated since brackets for the moorings and/or anchors on the wave power device may be above the water surface before the at least one ballast tank is filled with ballast. Also, the overall weight of the wave power device with the ballast tank(s) emptied becomes less than that of a wave power device with fixed ballast. This may facilitate some operations related to the present wave power device, for instance if the wave power device has to be lifted completely out of the water by a crane or barge or the like.

The at least one ballast tank may be provided inside the support structure. In this way, the interior of the support structure may conveniently be utilised, and the at least one ballast tank may be protected from outside interferences such as collisions with boats or the like.

The support structure may include a plurality of bulkheads 234 forming separated spaces within the support structure. This ensures that the wave power device does not sink, even if there is a leakage in one of the spaces. Each space may comprise or form a ballast tank.

The support structure may include a square or rectangular frame 216 and optionally four upright towers 218, one tower in each corner of the frame and the at least one panel being attached to the frame, wherein said frame and towers are at least partly hollow and contains the at least one ballast tank. Such a support structure may be very stable and robust.

The means for filling and emptying the at least one ballast tank may be adapted to allow movement of (ballast) water between the at least one ballast tank and the body of water. Hence, no dedicated source of ballast is needed except the body of water (e.g. the sea) in which the wave power device operates.

The means for filling and emptying the at least one ballast tank may further be adapted to forcibly move ballast into or out of the at least one ballast tank. The means for filling and emptying the at least one ballast tank may for instance include a pump.

The means for filling and emptying the at least one ballast tank may further be remote controlled, so that the wave power device for instance can be surfaced before any personnel has to access the wave power device.

The at least one ballast tank may be a plurality of ballast tanks 228′, 228″ distributed within the support structure, wherein the means for filling and emptying the at least one ballast tank is adapted to selectively fill or empty the different ballast tanks to provide an uneven flotation of the support structure. In this way, the wave power device may be tilted to one side so that portions of the support structure on the other side gets above the water surface, whereby maintenance and/or inspection readily can be carried out on these portions.

The wave power device may further comprise energy conversion means 226 adapted to convert the mechanical energy of the tilting or rotating motion of the panel to electrical energy. The energy conversion means may for instance include a hydraulics system, or an electrical generator mechanically coupled to the panel as disclosed above.

Further, the at least one ballast tank may be dimensioned such that the wave power device with filled ballast tank(s) is floating with the top of the at least one panel just above the surface of the body of water. In this position, the energy production is optimal.

Also, the at least one ballast tank may be dimensioned such that the wave power device with emptied ballast tank(s) is (floating) predominately above the surface of the body of water, for instance with the at least one panel completely above said surface. In this position, the panel(s) may be changed above the water surface, without having to use divers or an ROV (Remotely Operated underwater Vehicle) and without having to use a dedicated lifting equipment for the wave power device.

According to another aspect, there is provided a method of operating or managing a wave power device according to the above description, which method comprises at least one of: filling ballast into the at least one ballast tank to increase the floating depth of the wave power device; and emptying ballast from the at least one ballast tank to decrease the floating depth of the wave power device. This aspect may exhibit the same or similar features and technical aspects as the previously described aspect.

The at least one ballast tank may be a plurality of ballast tanks distributed within the support structure, wherein the method further comprises: selectively filling or emptying the different ballast tanks to provide an uneven flotation of the support structure.

Further, the at least one ballast tank may be emptied such that the wave power device is predominately above the surface of the body of water (see e.g. FIG. 2a).

The method may further comprise at least one of: towing the wave power device when the wave power device is predominately above said surface; and attaching moorings and/or anchors to brackets above the water surface on the wave power device when the wave power device is predominately above said surface.

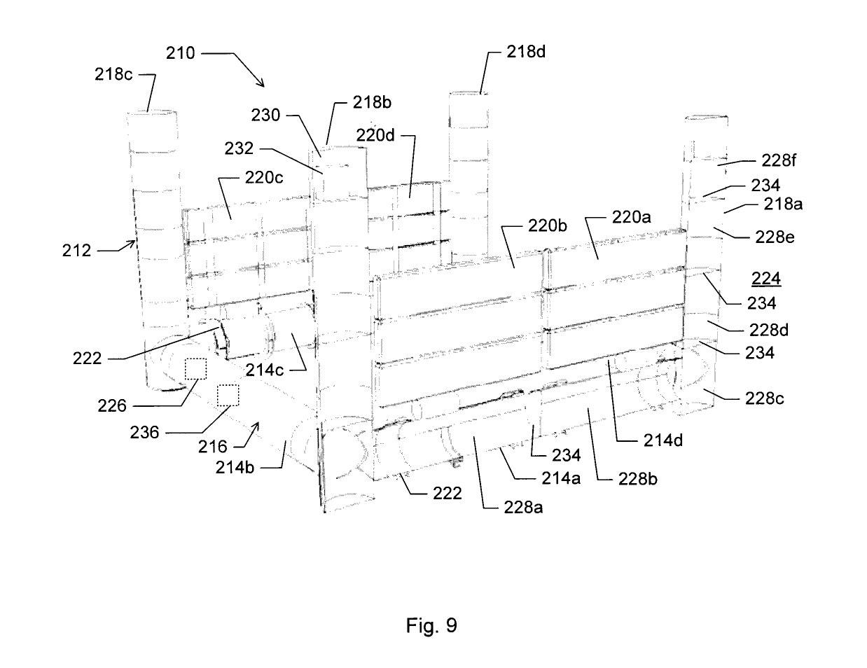

FIG. 9 is a perspective view, partly in cross-section, of a wave power device.

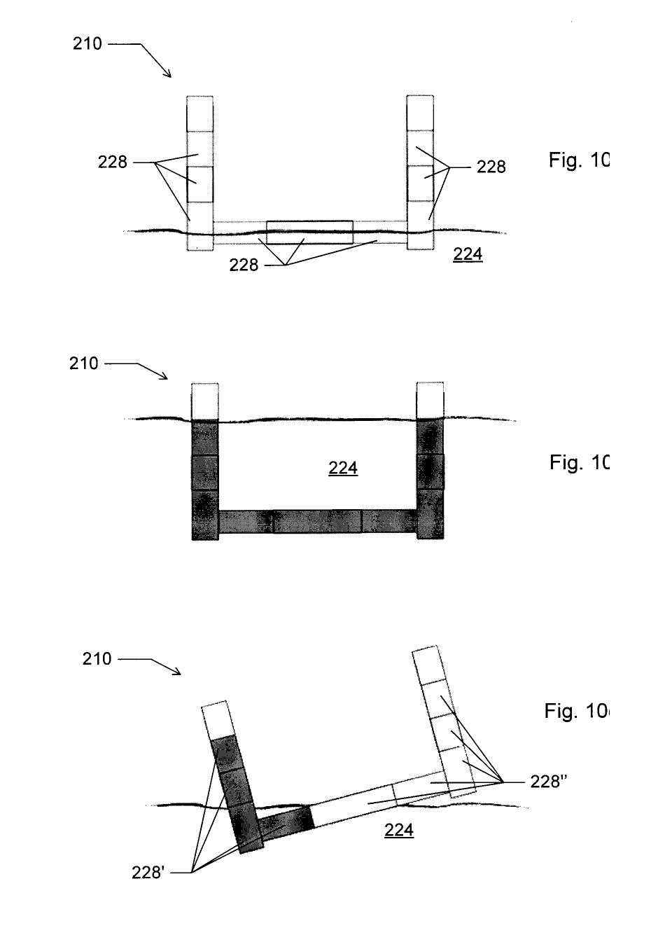

FIGS. 10a-10c schematically illustrates various states or positions of the wave power device of FIG. 9 in the sea.

FIG. 9 illustrates a wave power device or plant 210.

The wave power device 210 comprises a support structure 212. The support structure 212 includes four horizontal cylindrical tubes 214a-d forming part of a square or rectangular frame 216. At each corner of the square or rectangular frame 216, there is erected an upright tube or tower 218a-d. It should be noted that ‘horizontal’ and ‘upright’ (or ‘vertical’) here refers to an envisaged typical orientation of the wave power device 210 as shown in FIG. 9, but of course the actual orientation of the device 210 when in operation can vary e.g. due to incoming waves.

The wave power device 210 further comprises four panels 220a-d. Each panel 220 is in the form of a flap or wing. Two panels 220a-b are attached to one of horizontal tubes 214a, while the other two panels 220c-d are attached to the opposite horizontal tube 214c. Each panel 220 is horizontally hinged to its horizontal tube 214 by means of at least one bearing 222. Further, each panel 220 is buoyant or includes buoyant elements so that the panels 220, when the wave power device 210 is at least partly submerged in a body of water 224, strive towards the vertical. Alternatively or complementary, means for biasing the panels 220 towards the vertical may be included in the wave power device 210. Such means may for instance include springs or the like attached between the support structure and the panels.

The wave power device 210 may further comprise energy conversion means schematically indicated by reference sign 226. The energy conversion means 226 is adapted to convert the mechanical energy of the tilting or rotating motion of the panel 220 to electrical energy. The energy conversion means 226 may for instance include a hydraulics system, or an electrical generator mechanically coupled to the panel as mentioned above.

The wave power device 210 further comprises at least one ballast tank 228. The at least one ballast tank 228 generally serves as a means to control the (floating) depth of the wave power device 210 in the water 224. One or more ballast tank 228 may be arranged inside each of the tubes 214 and 218. In the example illustrated in FIG. 9, tube 214a contains two ballast tanks 228a-b, and upright tube 218a contains four ballast tanks 228c-f. Only a top compartment 230 of the upright tube 218a is reserved for other technical equipment 232. The other tubes 214b-d and 218b-d may be configured in the same way.

Further, bulkheads 234 may be provided inside the tubes 214 and 218, suitably between the ballast tanks 228. The bulkheads 234 form separated spaces within the support structure 212 to prevent the wave power device 210 from sinking should the support structure 212 start to leak. Also, in case of leakage in one space, another space may be filled with air to compensate for the increased weight.

The wave power device 210 further comprises means for filling and emptying the at least one ballast tank 228. Such means are schematically indicated by reference sign 236. The means 236 may designed to allow ballast water to move between the at least one ballast tank 228 and the water 224, so that suitably water from the body of water 224 in which the wave power device 210 is placed is used as ballast. The means 236 typically include a number of inlet/outlet valves and at least one pump. The latter may be used to forcibly remove ballast water from the ballast tank(s) 228, though other solutions for emptying the ballast tank(s) 228 are also envisaged. For instance, compressed air may be used to blow out the ballast tank(s) 228. The means 236 may further be remote controlled by means of radio equipment or the like (not shown).

Exemplary deployment and operation and maintenance of the wave power device 210 will now be described with further reference to FIGS. 10a-10c.

When the wave power device 210 is launched into the body of water 224, typically the sea, the ballast tank(s) 228 should be empty or almost empty. In this state (FIG. 10a), the wave power device 210 is floating “high” in the water 224. This means that a very deep body of water is not required for launching the device 210.

The wave power device 210 may then be transported to its operating position by means of a towing boat. Still without any significant ballast in the ballast tank(s) 228, the draft of the wave power device 210 is minimized. This facilitates the towing.

When the wave power device 210 has arrived at its operating position, moorings and/or anchors may be attached to brackets (not shown) on the wave power device 210 while the brackets still are over the water surface before the at least one ballast tank 228 is filled with water.

Then, the means 236 for filling and emptying the ballast tank(s) 228 are actuated so that water from the surrounding sea 224 fills the ballast tank(s) 228. Inlet valve(s) of the means 236 may for instance be opened, allowing water from the sea 224 into the ballast tank(s) 228. By filling the ballast tank(s) 228, the floating depth of the wave power device 210 is increased. Water should be filled into the at least one ballast tank 228 until the wave power device 210 is at least partly submerged in the sea 224 so that upper edges of the panels 220 when the latter are in a vertical position are just above the water surface. This position of the wave power device is illustrated in FIG. 10b.

In operation of the wave power device 210, waves approaching and passing the wave power device 210 move the panels 220, resulting in a tilting or rotating motion of the panels 220 relative to the support structure 212 (indicated by the curved arrow in FIG. 9), as in the above mentioned US2010111609, the contents of which herein is incorporated by reference. The mechanical energy of the tilting or rotating motion of the panel 20 is converted by the energy conversion means 226 to electrical energy.

The present support structure 212 in combination with the panels 220 is efficient when it comes to capturing wave energy. Since most of the support structure 212 is below the water surface, it is not affected that much by the waves and its movement is limited. It is also a very inert structure having high natural frequency in the water, much higher than the waves. Together with the much lighter panels 220 which follows the waves, the inert support structure 212 is almost still or stationary in the water and therefore the efficiency of the wave power device 210 is high.

At any time, the wave power device 210 may be surfaced and brought back to the position illustrated in FIG. 10a, by actuating the means 236 accordingly. For instance, one or more pump of the means 236 may be initiated to force water out from the ballast tank(s) 228 and back to the sea 224 via one or more outlet valves. The wave power device 210 may for instance be surfaced when an inspection or maintenance of the wave power device 210 is to be carried out. In that case, the wave power device 210 can easily be inspected or accessed from a boat, and divers or submarine equipment may not have to be used. The wave power device 210 may also suitably be surfaced when the wave power device 210 is to be re-deployed (e.g. towed) to a different location.

The ballast tanks of the wave power device 210 may also be selectively filled and emptied. In FIG. 10c, the ballast tanks 228′ on one side (left in FIG. 10c) of the device 210 are contains ballast water, while the ballast tanks 228″ on the other side (right in FIG. 10c) are empty. This causes an uneven flotation of the wave power device 210, which becomes tilted to one side so that portions of the support structure on the other side gets above the surface of the water 224. This allows maintenance and/or inspection to readily be carried out on these portions. Hence, it is possible to inspect the whole support structure 212, even portions which usually are under water when the support structure 212 is evenly ballasted, simply by adjusting the amount of ballast in different ballast tanks 228. The selective filling and emptying of the ballast tanks 228 may for instance be achieved by having one filling/emptying means 236 for each tank 228, or by including means for transferring ballast water between the different tanks.

The wave power device 210 may for instance be deployed in areas with moderate wave conditions, namely 2-6 meter seas, and they may form part of an offshore wind farm site.

1. A wave power device for converting energy of waves in a body of water to electrical energy, the device comprising:
a support structure;
a panel such as a flap or wing, hinged to the support structure, which panel is adapted to be moved by waves passing the device, resulting in a tilting or rotating motion of the panel relative to the support structure; and
an electrical generator mechanically coupled to the panel, which electrical generator is adapted to convert the mechanical energy of the tilting or rotating motion of the panel to electrical energy.

2. The wave power device according to claim 1, further comprising a gear mechanism, wherein the electrical generator is coupled to the panel via said gear mechanism.

3. The wave power device according to claim 2, wherein the gear mechanism has a gear ratio that increases the speed of the electrical generator compared to the tilting or rotating motion of the panel.

4. The wave power device according to claim 2, wherein the gear mechanism includes a larger diameter ring connected to the panel and provided with teeth, and a smaller diameter pinion connected to the electrical generator and adapted to mesh with the teeth of said ring.

5. The wave power device according to claim 4, wherein the support structure includes a substantially horizontal elongated element the panel is attached to the said element by means of at least one bearing provided around the element, said ring of the gear mechanism is also provided around said element, and the pinion is provided on an axis substantially parallel to said element.

6. The wave power device according to claim 2, wherein the gear mechanism includes a planetary gear at least partly provided inside a tube element of the support structure, and wherein the electrical generator is also provided inside said tube element.

7. The wave power device according to claim 6, wherein the planetary gear comprises:
one or more planet gears which partly extend outside the tube element through respective openings in the tube element, and
an outer ring gear which meshes with the planet gears at said openings, and which is connected to the panel such that rotation or tilting of the panel is transferred to said outer ring gear.

8. The wave power device according to claim 7, wherein the planetary gear further comprises:
a central sun gear which meshes with the planet gears and which is coupled to the electrical generator, and
a stationary carrier on which the planet gears are mounted.

9. The wave power device according to claim 7, further comprising a housing accommodating the outer ring gear, a drive ring attached on one hand to the outer ring gear via a house opening in said housing and on the other hand to said panel, and sealing members arranged to prevent any fluid or particles from entering said housing via said house opening.

10. The wave power device according to claim 6, wherein the gear mechanism includes, arranged between said planetary gear and electrical generator, at least one second planetary gear.

11. The wave power device according to claim 1, wherein the electrical generator is direct-coupled to the panel.

12. The wave power device according to claim 11, wherein the support structure includes a substantially horizontal elongated element the panel is attached to said element by means of at least one bearing provided around the element, and the electrical generator is ring-shaped and also provided around said element.

13. The wave power device according to claim 1, wherein at least one of the electrical generator and any gear mechanism is mounted on the outside of the support structure.

14. The wave power device according to claim 11, wherein the axis or center of rotation or tilting of the panel is inside the support structure.

15. The wave power device according to claim 11, further comprising at least one ballast tank provided inside the support structure, and means for filling and emptying the at least one ballast tank.

16. The wave power device according to claim 11, further comprising a release mechanism adapted to decouple the electrical generator when a force acting on the panel exceeds a particular value.

17. A method of using a wave power device according to claim 11 for converting energy of waves in a body of water to electrical energy by placing such a wave power device in the body of water.

18. A method for converting mechanical energy of a panel in a wave power device to electrical energy, wherein the wave power device includes a support structure and the panel is hinged to the support structure, the panel being adapted to be moved by waves passing the device resulting in a tilting or rotating motion of the panel relative to the support structure, which method comprises:
providing an electrical generator mechanically coupled to the panel, either directly or via a gear mechanism, the electrical generator being adapted to convert the mechanical energy of the tilting or rotating motion of the panel to electrical energy.

19. The wave power device of claim 1, wherein the panel is a flap or a wing.

20. The wave power device of claim 5, wherein the substantially horizontal elongated element is a bar or tube.
